(19) United States
(12) Patent Application Publication
(10) Pub. No.: US 2007/0288838 A1
(43) Pub. Date: Dec. 13, 2007

(54) PERSONAL NAME ENTERING METHOD AND ELECTRONIC APPARATUS

(76) Inventor: Tianyi Lin, Tokyo (JP)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 11/696,274

(22) Filed: Apr. 4, 2007

(30) Foreign Application Priority Data
Apr. 7, 2006 (JP) 2006-106201

(51) Int. Cl. G06F 15/00

(52) U.S. Cl. 715/508

(57) ABSTRACT

With a view to entering the name of the same person in a plurality of forms onto a user interface with high space efficiency, in entering the personal name onto the user interface of an electronic apparatus, the name of the same person is entered in a plurality of sections of the same entry box in a plurality of forms. One of the plurality of sections is larger than the others. One section permits inputting and editing of characters. Entries in the plurality of sections can be scrolled beyond their partitioning. The other sections can be enlarged. The enlarged section permits inputting and editing of characters. The plurality of forms are a Chinese character form, a kana form and an alphabetic letter form. The user interface conforms to the DICOM standards. A personal name in a plurality of forms constitutes a name string conforming to the DICOM standards. The electronic apparatus is an ultrasonic diagnostic apparatus.

### BACKGROUND OF THE INVENTION

The present invention relates to a personal name entering method and an electronic apparatus, and more particularly to a method of entering a personal name on the user interface of an electronic apparatus and to an electronic apparatus having a user interface for entering personal names.

In electronic apparatuses for medical use, such as an ultrasonic diagnostic apparatus, various items of information are inputted or displayed through a user interface. The items of inputted/displayed information include patient information. The patient information includes the full name of the patient (see Patent Document 1 for instance).

[Patent Document 1] JP-A No. 278741/2005

In Japan, there are three forms of notating personal names including the Chinese character notation, kana notation, and alphabetical notation, and names are notated in a way or ways compatible with the user interface. If the user interface is compatible with every form of notation, personal names are entered in all the three forms.

In that case, since entry boxes are required each matching one or another of the different forms, they occupy a correspondingly larger area on the user interface. This area is disproportionately large for the personal name, which is merely one of many items of information.

### SUMMARY OF THE INVENTION

Therefore, an object of the present invention is to provide a space-efficient method and an electronic apparatus for entering a personal name of the same person in a plurality of forms on a user interface. Incidentally in this document, entering means both inputting and displaying.

In order to solve the problem noted above, one aspect of the invention is a method of entering a personal name onto the user interface of an electronic apparatus, which is a personal name entering method characterized in that the same personal name is notated in a plurality of forms in a plurality of sections in the same entry box.

In order to solve the problem noted above, another aspect of the invention is an electronic apparatus having a user interface onto which a personal name is to be entered, characterized in that it is provided with entering means by which the same personal name is notated in a plurality of forms in a plurality of sections in the same entry box.

It is preferable from the viewpoint of making the principal notation distinct for one out of the plurality of sections to be larger than the others.

It is preferable from the viewpoint of enhancing convenience for the one section to permit inputting and editing of characters.

It is preferable from the viewpoint of changing over the principal notation for entries in the plurality of sections to permit scrolling beyond the partitioning thereof.

It is preferable from the viewpoint of improving visibility for the other sections to be enlargeable.

It is preferable from the viewpoint of enhancing convenience for the enlarged section to permit inputting and editing of characters.

It is preferable from the viewpoint of enhancing convenience in Japan for the plurality of forms to be a Chinese character form, a kana form, and an alphabetic letter form.

It is preferable from the viewpoint of enhancing harmony with other medical equipment conforming to the DICOM standards for the user interface to conform to the DICOM standards.

It is preferable from the viewpoint of enhancing compatibility with the DICOM standards for the personal name in a plurality of forms to constitute a name string conforming to the DICOM standards.

It is preferable from the viewpoint of enhancing the convenience of entering the patient's name for the electronic apparatus to be an ultrasonic diagnostic apparatus.

According to the present invention, since the same personal name is notated, in entering a personal name on the user interface of an electronic apparatus, in a plurality of forms in a plurality of sections in the same entry box, there can be provided a method and an electronic apparatus by which the name of the same person in the plurality of forms can be entered in the user interface with high space efficiency.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram of an ultrasonic diagnostic apparatus representing one example of best mode for carrying out the present invention.

FIG. 2 is a block diagram of an image processing unit.

FIG. 3 shows an example of user interface.

FIG. 4 shows an example of personal name entry.

FIG. 5 shows an example of personal name entry.

FIG. 6 shows an example of personal name entry.

### DETAILED DESCRIPTION OF THE INVENTION

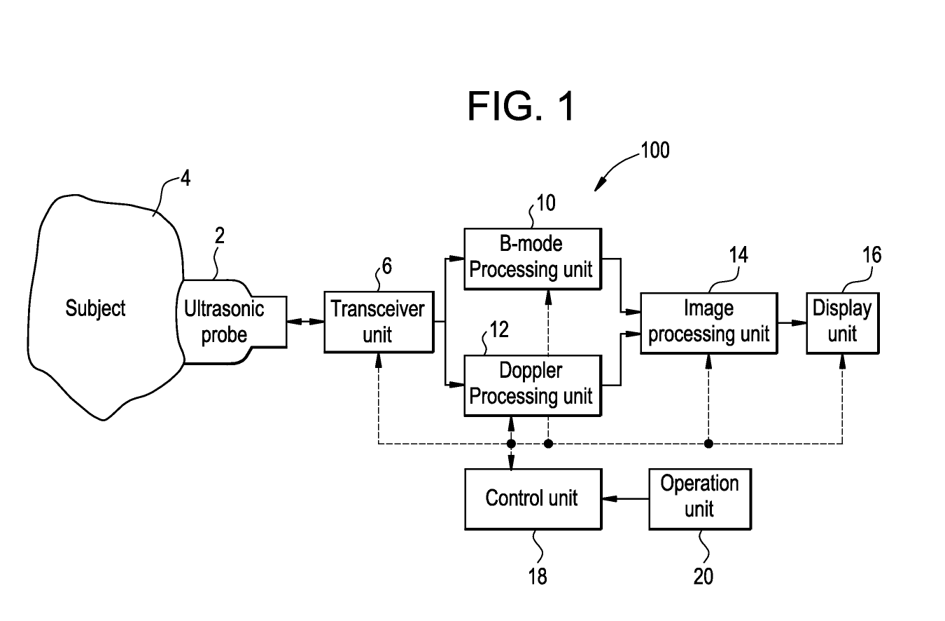

A best mode for carrying out the invention will be described in detail below with reference to drawings. Incidentally, the invention is not limited to this best mode for carrying it out. FIG. 1 shows a block diagram of an ultrasonic diagnostic apparatus 100. This apparatus is one example of best mode for carrying out the invention. The configuration of this apparatus represents an example of best mode for carrying out the invention with respect to an electronic apparatus. The operation of this apparatus represents an example of best mode for carrying out the invention with respect to a personal name entering method.

As shown in FIG. 1, this apparatus has an ultrasonic probe 2. The ultrasonic probe 2 has an array of ultrasonic transducers. Each of the individual ultrasonic transducers in the array is formed of a piezoelectric material, such as PZT (lead zirconium titanate) ceramic. The ultrasonic probe 2 is used in contact with a subject 4 by the operator.

The ultrasonic probe 2 is connected to a transceiver unit 6. The transceiver unit 6 supplies drive signals to the ultrasonic probe 2 to have an ultrasonic wave transmitted. The transceiver unit 6 also receives echo signals received by the ultrasonic probe 2.

The transmission and reception of the ultrasonic wave are performed while scanning the imaging range with sound rays. The sound rays are formed of ultrasonic beams. The sound-ray scanning is accomplished by a sector scan, a convex scan, a linear scan or the like.

The transceiver unit 6 is connected to a B-mode processing unit 10 and a Doppler processing unit 12. Echo reception signals for each sound ray outputted from the transceiver unit 6 are inputted to the B-mode processing unit 10 and the Doppler processing unit 12.

The B-mode processing unit 10 is intended to create B-mode images. The B-mode processing unit 10, obtaining signals representing the intensities of echo at individual reflection points on sound rays, creates a B-mode image with the instantaneous amplitude of each of these signals as the brightness value.

The Doppler processing unit 12 is intended to create Doppler images. The Doppler processing unit 12 figures out the complex Doppler signals of echoes by subjecting I and Q signals obtained by orthogonal detection of echo reception signals to MTI (Moving Target Indication) processing, and forms a Doppler image for each sound ray by prescribed arithmetic operation regarding complex Doppler signals.

The Doppler image is created as a color Doppler or a power Doppler image. The color Doppler image represents the distribution of flow rates. The power Doppler image represents the distribution of powers of Doppler signals.

The B-mode processing unit 10 and the Doppler processing unit 12 are connected to an image processing unit 14. The image processing unit 14 generates images to be displayed on the basis of image data inputted from the B-mode processing unit 10 and the Doppler processing unit 12.

The B-mode images are generated as brightness images having no hue. Both the color Doppler images and the power Doppler images are generated as color images. A color Doppler image expresses the relative velocity in color brightness and the direction of velocity in hue. A power Doppler image expresses the magnitude of power in color brightness.

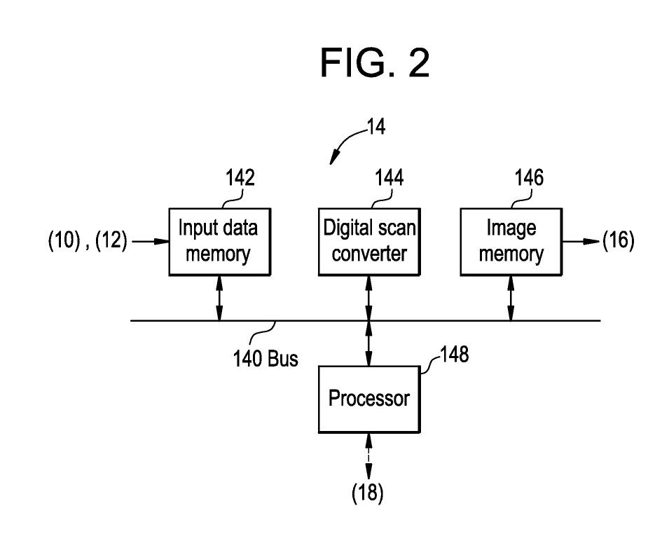

The image processing unit 14, as shown in FIG. 2, is provided with an input data memory 142, a digital scan converter 144, an image memory 146 and a processor 148, connected by a bus 140.

B-mode images and Doppler images inputted from the B-mode processing unit 10 and the Doppler processing unit 12 for each sound ray are stored into the input data memory 142. The data stored into the input data memory 142 are also referred to as sound-ray data. The sound-ray data undergo scan conversion by the digital scan converter 144 and stored into the image memory 146. The data stored into the image memory 146 are also referred to as image data.

The processor 148, as the key element of the image processing unit 14, performs processing of sound-ray data and image data, reading out of and writing into the input data memory 142 and the image memory 146 and control of the digital scan converter 144, and the like.

A display unit 16 is connected to the image processing unit 14. The display unit 16, to which image signals are supplied from the image memory 146 of the image processing unit 14, displays an image based on the image signals. The display unit 16 is formed of a graphic display capable of displaying color images.

A control unit 18 is connected to these transceiver unit 6, B-mode processing unit 10, Doppler processing unit 12, image processing unit 14 and display unit 16. The control unit 18 controls those units by supplying control signals to them. Also, various notification signals are inputted to it from the controlled units. Under the control of the control unit 18, B-mode imaging operation and Doppler mode imaging operation are executed.

An operation unit 20 is connected to the control unit 18. The operation unit 20 is operated by the operator, who inputs various instructions and information to the control unit 18. The operation unit 20 is configured as an operation panel equipped with operation tools such as a keyboard, a pointing device and others.

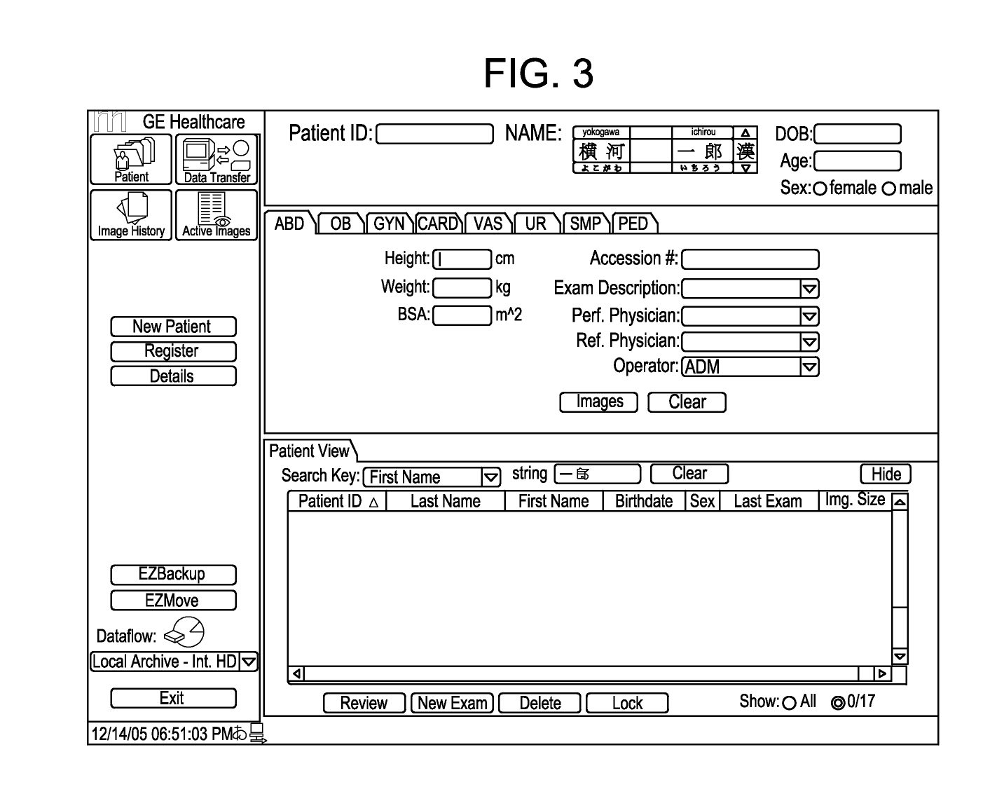

FIG. 3 shows an example of screen displayed on the display unit 16. This screen is a user interface. This user interface is an example of user interface according to the invention.

As shown in FIG. 3, the user interface has a personal name entry box 300 at the top of the screen. The personal name entry box 300 is a box in which the patient's name is entered. The personal name entry box 300 is one example of entry box according to the invention. The personal name entry box 300 also is one example of entering means according to the invention.

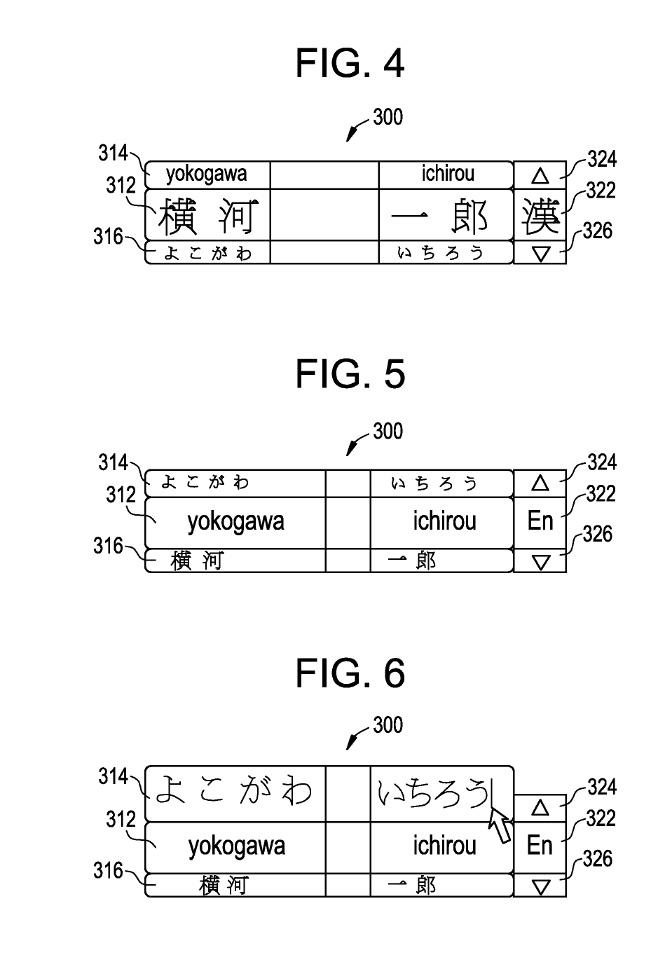

FIG. 4 shows the configuration of the personal name entry box 300. As shown in FIG. 4, the personal name entry box 300 has three sections 312, 314 and 316. The sections 312, 314 and 316 constitute one example of sections according to the invention.

All the three sections 312, 314 and 316 are horizontal strip-shaped sections, arranged in three stages one over another. Every one of the sections 312, 314 and 316 is further divided vertically into three parts.

The three sections 312, 314 and 316 are equal in transverse size, but the middle section differs in vertical size from the top and bottom sections. The vertical size of the middle section 312 is, for instance, twice those of the top and bottom sections 314 and 316. Incidentally, the magnification is not limited to twice, but may be three times, 1.7 times or any other appropriate rate. In the following description the transverse size may be sometimes referred to as the length, and the vertical size, as the width.

The middle section 312 having the greatest width is the principal part of the personal name entry box 300, and the full name is written here in Chinese characters. The narrower top and bottom sections 314 and 316 are auxiliary parts of the personal name entry box 300, and the full name is written there in alphabetical letters and kana, respectively.

The writing direction is from left to right, and in each section the leftmost subsection bears the family name and the rightmost subsection, the first name. Incidentally, the central section is allocated for the middle name, and usually left blank if the person is a Japanese.

As the full name of the same person in the Chinese character form, the kana form and the alphabetical form are written by using the plurality of sections of the same entry box, the occupied area of the user interface is small relative to the quantity of information that is expressed. Therefore, space-efficient entry of personal names can be accomplished.

Also, since the full name in the Chinese character form, the kana form and the alphabetical form can be collectively written in the same box, the user can recognize the full name in the three forms at a glance. Moreover, as the name in Chinese characters, which is the official form in Japan, is written in the largest size, and supplementary notations in kana and alphabetic letters are written in smaller size, this style matches the domestic practice of personal name notation.

An indicator 322 is provided to the right of the section 312. The indicator 322 indicates the form of notation in the section 312. In FIG. 3, as the notation in the section 312 is in Chinese characters, [symbol] is shown.

Scroll buttons 324 and 326 are provided above and underneath the indicator 322, respectively. The scroll buttons 324 and 326 are for upward scrolling and downward scrolling, respectively.

By performing upward scrolling, the alphabetic entry in the top section 314 can be shifted to the middle section 312. By performing downward scrolling, the kana entry in the bottom section 316 can be shifted to the middle section 312. This arrangement enables the full name in the desired form of notation to be displayed in the principal part of the personal name entry box, resulting in enhanced convenience for the user.

The state resulting from upward scrolling is shown in FIG. 5. As shown in FIG. 5, the alphabetic entry comes to the middle section 312. Along with that, the reading in the indicator becomes “en”, indicating the alphabetic (English) notation. The vertical partitioning line shifts to match the number of characters.

In the state resulting from downward scrolling, though not shown, the kana entry comes to the middle section 312. Along with that, the reading in the indicator becomes “kana”, indicating the kana notation.

Characters are inputted to the middle section 312. For character inputting, the keyboard of the operation unit 20 is used. Input signals from the keyboard are converted by the converting function of the control unit 18 into Chinese characters, kana or alphabetic letters according to the mode of the middle section 312.

Characters may as well be directly inputted to the top section 314 and the bottom section 316. An example of this is shown in FIG. 6. When the top section 314 is selected with a pointing device as shown in FIG. 6, the section 314 is enlarged in width to become about equal to the middle section 312. By inputting characters in this state, character inputting can be accomplished with about as good visibility as in inputting to the middle section 312. The same applies to inputting to the bottom section 316.

Such a user interface conforms to the DICOM (Digital Imaging and Communications in Medicine) standards. And a personal name in a plurality of forms constitutes the following name string conforming to the DICOM standards.

Yokogawa'ichirou=

[symbol]

[symbol]

This contributes to enhancing harmony with other medical equipment conforming to the same standards.

While the user interface described above is a user interface used in an ultrasonic diagnostic apparatus, the applicable user interface is not limited to one for ultrasonic diagnostic apparatuses, but may be a user interface of some other electronic apparatus for medical use, such as an X-ray CT (Computed Tomography) apparatus or an MRI (Magnetic Resonance Imaging) apparatus, or of an electronic apparatus for use in a non-medical field. Further, not only Japanese personal names but also Chinese, Korean or Western personal names can be handled in a unified way. Although a case in which the personal name is written horizontally was described above, it may as well be written vertically.

Many widely different embodiments of the invention may be configured without departing from the spirit and the scope of the present invention. It should be understood that the present invention is not limited to the specific embodiments described in the specification, except as defined in the appended claims.

1. A method of entering a personal name onto the user interface of an electronic apparatus, wherein:
the same personal name is notated in a plurality of forms in a plurality of sections in the same entry box.

2. The personal name entering method according to claim 1, wherein:
one out of said plurality of sections is larger than the others.

3. The personal name entering method according to claim 2, wherein:
said one section permits inputting and editing of characters.

4. The personal name entering method according to claim 2, wherein:
entries in said plurality of sections can be scrolled beyond the partitioning thereof.

5. The personal name entering method according to claim 1, wherein:
said other sections can be enlarged.

6. The personal name entering method according to claim 5, wherein:
said enlarged sections permit inputting and editing of characters.

7. The personal name entering method according to claim 1, wherein:
said plurality of forms are a Chinese character form, a kana form and an alphabetic letter form.

8. The personal name entering method according to claim 1, wherein:
said user interface conforms to the DICOM standards.

9. The personal name entering method according to claim 8, wherein:
said personal name in a plurality of forms constitutes a name string conforming to the DICOM standards.

10. The personal name entering method according to claim 1, wherein:
said electronic apparatus is an ultrasonic diagnostic apparatus.

11. An electronic apparatus having a user interface onto which a personal name is to be entered, comprising:
an entering device by which the same personal name is notated in a plurality of forms in a plurality of sections in the same entry box.

12. The electronic apparatus according to claim 1, wherein:
one out of said plurality of sections is larger than the others.

13. The electronic apparatus according to claim 12, wherein:
said one section permits inputting and editing of characters.

14. The electronic apparatus according to claim 12, wherein:
entries in said plurality of sections can be scrolled beyond the partitioning thereof.

15. The electronic apparatus according to claim 11, wherein:
said other sections can be enlarged.

16. The electronic apparatus according to claim 15, wherein:
said enlarged sections permit inputting and editing of characters.

17. The electronic apparatus according to claim 11, wherein:
said plurality of forms are a Chinese character form, a kana form and an alphabetic letter form.

18. The electronic apparatus according to claim 11, wherein:
said user interface conforms to the DICOM standards.

19. The electronic apparatus according to claim 18, wherein:
said personal name in a plurality of forms constitutes a name string conforming to the DICOM standards.

20. The electronic apparatus according to claim 11, wherein:
said electronic apparatus is an ultrasonic diagnostic apparatus.
